(19) United States
(12) Patent Application Publication
(10) Pub. No.: US 2012/0242985 A1
(43) Pub. Date: Sep. 27, 2012

(54) PATTERN INSPECTION APPARATUS AND PATTERN INSPECTION METHOD

(75) Inventors: Mitsutoshi WATABIKI, Yokkaichi-shi (JP); Yusuke Iida, Yokkaichi-shi (JP); Makoto Kaneko, Yokkaichi-shi (JP); Yuichiro Yamazaki, Yokkaichi-shi (JP); Yusaku Konno, Yokohama-shi (JP); Shinichi Imai, Tokyo (JP); Takayoshi Fujii, Yokohama-shi (JP)

(73) Assignee: Kabushiki Kaisha Toshiba, Tokyo (JP)

(21) Appl. No.: 13/418,940

(22) Filed: Mar. 13, 2012

(30) Foreign Application Priority Data
Mar. 25, 2011 (JP) 2011-068507

(51) Int. Cl. G01N 21/55

(52) U.S. Cl. 356/237.5

(57) ABSTRACT

In accordance with an embodiment, a pattern inspection apparatus includes a stage supporting a substrate with a pattern, a light source irradiating the substrate with light, a detection unit, an optical system, a focus position change unit, a control unit, and a determination unit. The detection unit detects reflected light from the substrate. The optical system leads the light from the light source to the substrate and leads the reflected light to the detection unit. The focus position change unit changes a focus position of the light to the substrate in a direction vertical to the surface of the substrate. The control unit associates the movement of the stage with the light irradiation and controls the stage drive unit and the focus position change unit, thereby changing the focus position. The determination unit determines presence/absence of a defect of the pattern based on the signal from the determination unit.

### CROSS REFERENCE TO RELATED APPLICATIONS

This application is based upon and claims the benefit of priority from the prior Japanese Patent Application No. 2011-068507, filed on Mar. 25, 2011, the entire contents of which are incorporated herein by reference.

### FIELD

Embodiments described herein relate generally to a pattern inspection apparatus and a pattern inspection method.

### BACKGROUND

In the fields of semiconductor devices, flat panel displays, MEMS (micro electro mechanical systems) and others, a structure having a fine pattern formed on a surface thereof (which will be referred to as a “fine structure” hereinafter) is manufactured using a lithography technology or another.

For Inspection of such a fine structure, an optical inspection apparatus is used. Heretofore, in the optical inspection apparatus, a defect inspection is carried out by fixing a focus plane onto the surface of the pattern with the aid of an autofocus function, scanning the surface of a substrate such as a wafer with light in a horizontal direction to form an image of reflected light from the wafer surface onto a detector, and evaluating an obtained pattern image, or detecting a difference in reflectance between a defect-free position and a defective position.

In recent years, however, with the progress of miniaturization or high integration in the fine structure, a pattern having a high aspect ratio is formed. For example, in the case of a trench pattern having a high aspect ratio, defects may be possibly produced at various positions in a depth direction, and when a focus plane is fixed on the surface of the pattern, a focus does not match with a defect, and hence there is a problem that it is hard to obtain reflected light which reflects an accurate shape from a wafer surface.

### BRIEF DESCRIPTION OF THE DRAWINGS

FIG. 1 is a schematic view showing an outline configuration of a pattern inspection apparatus according to an embodiment;

FIG. 2 is a schematic view showing an outline configuration of a pattern inspection apparatus according to a comparative example;

FIGS. 3A and 3B are each a perspective view and a cross-sectional view showing an example of a fine structure;

FIG. 4 is a schematic view showing a drawback of the pattern inspection apparatus according to the comparative example;

FIG. 5 is a schematic view showing a method for using the pattern inspection apparatus depicted in FIG. 1 to carry out a defect inspection based on a die-to-die comparison;

FIG. 6 is a graph chart showing an example of wavelength-dependence of a reflectance from a defect detected by the pattern inspection apparatus depicted in FIG. 1;

FIG. 7 is a schematic view showing a basic light source unit for generating deep ultraviolet light; and

FIGS. 8A and 8B are schematic views each showing a broadband light source using the basic light source units depicted in FIG. 7.

### DETAILED DESCRIPTION

In accordance with an embodiment, a pattern inspection apparatus includes a stage, a stage drive unit, a light source, a detection unit, an optical system, a focus position change unit, a control unit, and a determination unit. The stage is configured to support a substrate with a pattern thereon as an inspection target. The stage drive unit is configured to move the stage in a direction horizontal to the surface of the substrate. The light source is configured to Irradiate the substrate with light. The detection unit is configured to detect reflected light from the substrate irradiated with the light and output a signal. The optical system is configured to lead the light emitted from the light source to the substrate and lead the reflected light from the substrate to the detection unit. The focus position change unit is configured to change a focus position of the light to the substrate in a direction vertical to the surface of the substrate. The control unit is configured to associate the movement of the stage with the light irradiation to the pattern and control the stage drive unit and the focus position change unit in a manner that the focus position changes. The determination unit is configured to determine presence/absence of a defect of the pattern based on the signal from the determination unit.

Embodiments will now be explained with reference to the accompanying drawings. It is to be noted that like reference numerals denote like constituent elements in the respective drawings to appropriately omit repeated description.

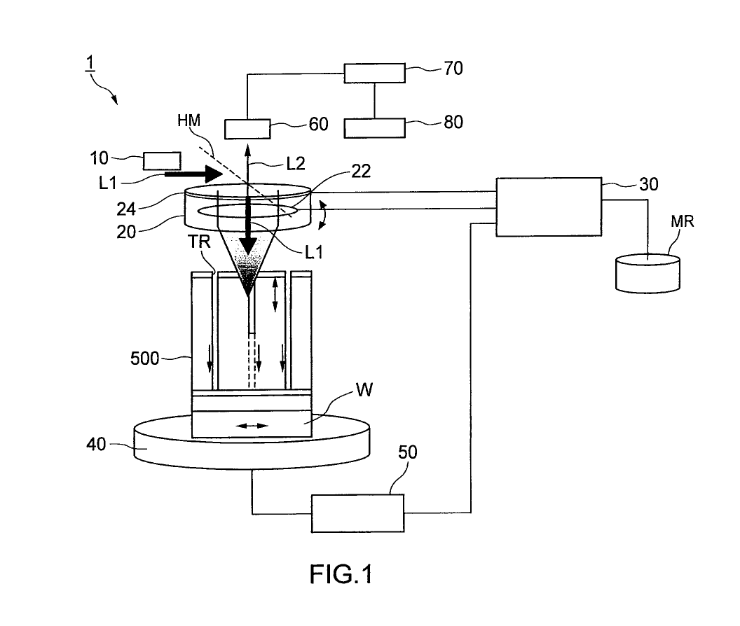

FIG. 1 is a schematic view showing a pattern inspection apparatus according to an embodiment of the present invention.

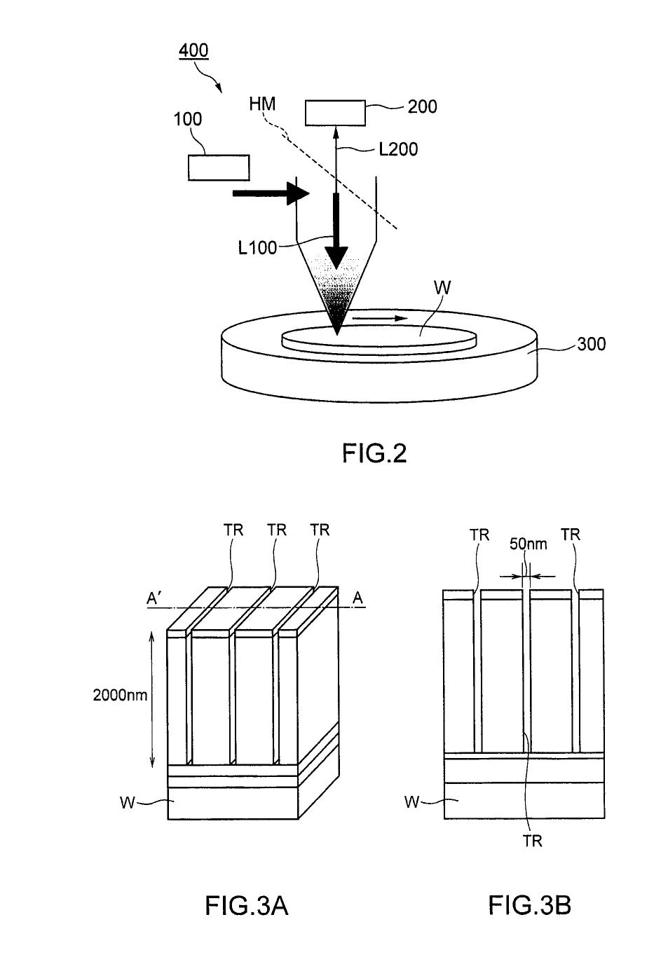

FIG. 2 is a schematic view showing a pattern inspection apparatus according to a comparative example.

### (1) Comparative Example

First of all, a comparative example examined by the present inventor in a process for developing the present invention will be described.

In a pattern inspection apparatus 400 according to the comparative example depicted in FIG. 2, a light source 100, a half mirror HM, a wafer stage 300, and a detector 200 are provided. The pattern inspection apparatus 400 is provided with an autofocus function, whereby a focal position is automatically adjusted in such a manner that light L100 emitted from the light source 100 and reflected on the half mirror HM can be just focused on the surface of a wafer W. A pattern as an inspection target is formed on the surface of the wafer W.

Furthermore, when the wafer stage 300 on which the wafer W is placed is moved in a direction horizontal to the wafer surface in a state that the focal position is fixed, the wafer W is scanned with the light L100 in the direction horizontal to the wafer surface. Light L200 reflected from the wafer by the emission of the light L100 is transmitted through the half mirror HM to form an image on a detection plane of the detector 200, and an image of the pattern as the inspection target is formed from the resultant signal. On the basis of this image, presence/absence of defects is determined.

However, in recent years, with the further progress of miniaturization or high integration of fine structures, an aspect ratio of the pattern which is the inspection target is heightened.

FIG. 3A is a perspective view showing an example of such a fine structure, and FIG. 3B is a cross-sectional view taken along a line A-A of the fine structure depicted in FIG. 3A. In the fine structure shown in FIG. 3, trench patterns TR are formed at a predetermined pitch in an insulating layer formed on the wafer W.

In the example of FIG. 3, a trench width of the trench pattern TR is 50 nm, and a depth of the same is 2000 nm. An aspect ratio of the trench pattern TR is thus 2000/50=40, and such an aspect ratio tends to further increase in the future.

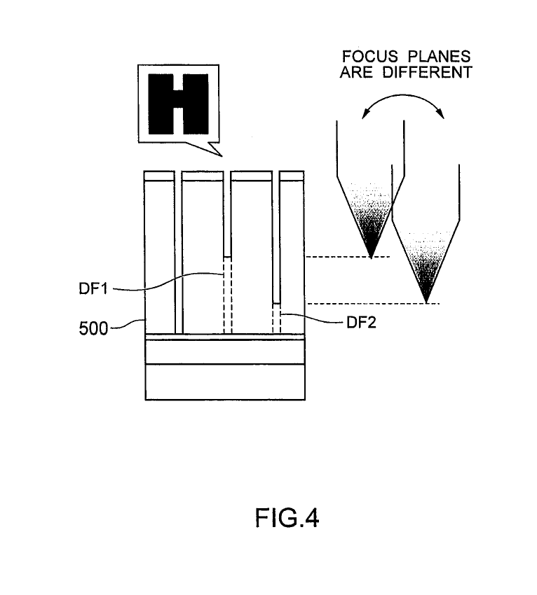

In such a trench pattern having a high aspect ratio, defects at different depths may be possibly formed, as indicated by reference characters DF1 and DF2 in FIG. 4.

When performing a defect inspection for such an inspection target pattern by use of the pattern inspection apparatus 400 depicted in FIG. 2, a focus plane differs depending on a depth of each defect, and hence it is difficult to obtain an appropriate pattern image. This reason is that even if any position of a top face of a single layer film or a laminated layer film 500, a top face of the defect DF1 and a top face of the defect DF2 is just focused as shown in FIG. 4, reflected light which reflects correct shapes Is not returned from irradiation targets at the other positions (depths).

### (2) Embodiment

Again referring to FIG. 1, a pattern inspection apparatus according to this embodiment will be described.

In a pattern inspection apparatus 1 depicted in FIG. 1, a light source 10, a column 20, a control unit 30, a memory MR, a stage 40, a stage controller 50, a detector 60, a signal processing unit 70, and a defect determination unit 80 are provided. The light source 10 emits light L1. The column 20 includes an optical system including a half mirror HM and an objective lens 22, reflects the light L1 on the half mirror to direct a light path toward a wafer W, and controls a focal position by use of the objective lens 22 to irradiate the wafer W with the light.

The objective lens 22 is formed of an electric-optical (EO) element that electrically changes a refractive index, and it changes a focus position of the light L1 according to a control signal supplied from the control unit 30. A piezo element 24 is provided on the column 20 to vibrate the column 20 in a direction vertical to the surface of the wafer W according to the control signal supplied from the control unit 30. In this embodiment, the control unit 30 and at least one of the objective lens 22 and the piezo element 24 correspond to, e.g., a focus position varying unit.

A single layer film or a laminated layer film 500 is formed on the wafer W, and in the single layer film or the laminated layer film 500, trench patterns TR as inspection targets are formed. The wafer W corresponds to, e.g., a substrate in this embodiment.

Light L is reflected on the wafer W, and reflected light L2 enters the column 20. In the column 20, the reflected light L2 is led to the detector 60 through the half mirror HM to form an optical image on a detection plane of the detector 60.

The wafer W is placed on the stage 40, and the stage 40 moves the wafer W in a direction horizontal to a wafer plane according to a control signal supplied from the stage controller 50. As a result, the wafer W Is scanned with the light L1 in the direction horizontal to the wafer plane. The stage controller 50 generates a control signal, which is used for driving the stage 40, according to an instruction signal from the control unit 30. The stage 40, the stage controller 50, and the control unit 30 correspond to, e.g., a stage drive unit in this embodiment.

The detector 60 photoelectrically converts the light L2 that forms image on the detection plane thereof and outputs a detection signal. The detector 60 is constituted of, e.g., an infrared charge coupled device (CCD) or a photo-multiplier. However, the detector 60 is not restricted thereto, and it is possible to appropriately select any detector that can photoelectrically convert the light for image formation.

The signal processing unit 70 processes the detection signal supplied from the detector 60 to generate an image on the surface of the single layer film or the laminated film 500 including the trench patterns TR. The defect determination unit 80 processes the image supplied from the signal processing unit 70 to determine presence/absence of defects and others in the trench patterns TR based on, e.g., a die-to-die comparison or a cell-to-cell comparison. In this embodiment, the defect determination unit 80 corresponds to, e.g., a determination unit.

The memory MR stores a recipe file in which an inspection algorithm for executing a later-described defect inspection method is written, and it also stores a design database of the trench patterns TR as the inspection target including three-dimensional positional information.

The control unit 30 reads the recipe file from the memory MR, generates the above-described various kinds of control signals according to the written inspection algorithm, and supplies the generated control signals to the stage controller 50, the objective lens 22, and the piezo element 24 of the column 20.

Next, description will be given as to an example of a method of performing a defect inspection by use of the pattern inspection apparatus depicted in FIG. 1.

First, a non-illustrated alignment pattern or the like is used to associate an X-Y coordination system of the stage 40 with pattern positional information in the design database stored in the memory MR.

Next, the control unit 30 generates the control signal while irradiating the wafer W with the light L1 from the light source 10, and the stage 40 is moved so that the trench patterns TR in an inspection target region can be sequentially scanned with the light L1 by the stage controller 50. Furthermore, when the light L1 is placed immediately above the trench pattern TR, the control unit 30 generates the control signal and supplies it to the objective lens 22 or the piezo element 24, whereby a focus position of the light L1 changes in a direction vertical to the surface of the wafer W.

Moreover, the light L1 is condensed by the objective lens 22 at each focus position so that the light L1 can be applied to the wafer W and reflected thereon, so that optical images at different depths in the trench patterns TR are formed on the detection plane of the detector 60. Then, the signal processing unit 70 generates a plurality of pattern images regarding the same trench pattern TR, and the defect determination unit 80 determines presence/absence of defects.

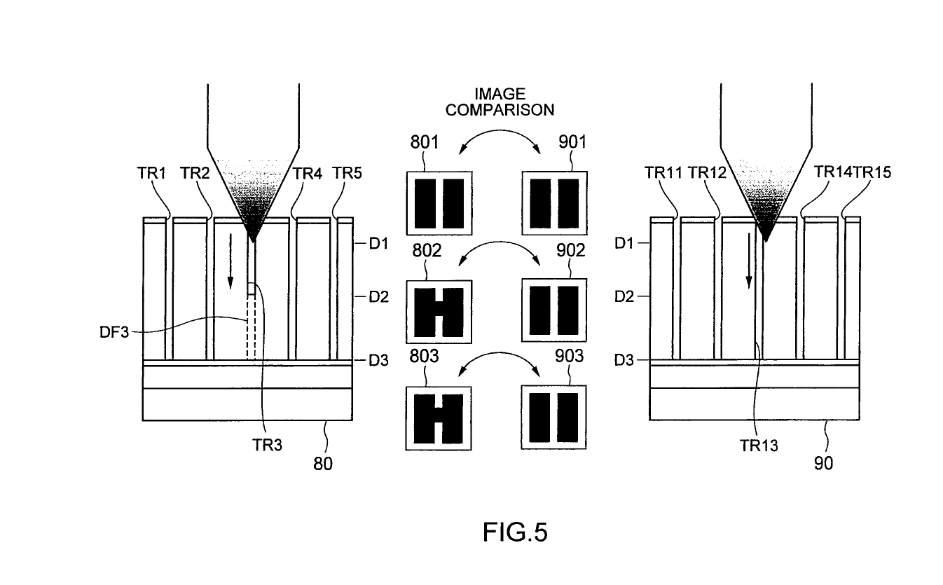

An example of a method of determining the defects based on the die-to-die comparison will be explained with reference to FIG. 5.

For example, a comparison will now be made between a die having a defect DF in which etching has been performed only to a depth D2 in a trench pattern TR3 due to an influence of, e.g. an impurity as a die 80 shown on the left side of FIG. 5 and a defect-free die which has been successfully processed as a die 90 shown on the right side of FIG. 5.

When a focus position is changed so that just focusing can be achieved at each position of, e.g., depths D1, D2 and D3 at timing that irradiation light reaches a position of each trench pattern by the movement of the stage 40, three pattern images can be obtained for each trench pattern, and eventually six pattern Images can be obtained from the die 80 and the die 90.

In the example of FIG. 5, the same pattern image can be obtained from each of a pair of trench patterns TR1 and TR11, a pair of TR2 and TR12, a pair of TR3 and TR13 and a pair of TR4 and TR14, and hence no defect can be detected.

Additionally, when a pattern image 801 obtained from the trench pattern TR3 at the depth D1 is compared with a pattern image 901 obtained from the trench pattern TR13 at the depth D1, both the pattern images are defocus images, but between these images, a difference is scarcely present, and a defect cannot be detected.

However, comparing a pattern image 802 obtained from the trench pattern TR3 at the depth D2 with a pattern image 902 obtained from the trench pattern TR13 at the depth D2, although the pattern image 902 is a defocus image, line patterns vertically extending in the image are shorted to each other at a middle point in the pattern image 802 and, on the other hand, such a short is not present in the pattern image 902. Therefore, it is determined that a defect DF3 is present in the trench pattern TR3 of the die 80.

Additionally, comparing a pattern image 803 obtained from the trench pattern TR3 at the depth D3 with a pattern image 903 obtained from the trench pattern TR13 at the depth D3, the pattern image 803 is a defocus image but is considerably different from the pattern image 903, and it is determined that the defect DF3 is present after all. In this embodiment, the pattern images 801 to 803 correspond to, e.g., a first image, respectively, and the pattern images 901 to 903 correspond to, e.g., a second image, respectively.

It is to be noted that reference has been made to the defect-free die 90 in the above determination but, if presence of a defect is unclear in the die 90, the defect determination is carried out based on double comparisons including a comparison with another die like a general die-to-die comparison.

As described above, in accordance with this embodiment, since the focus position is changed in not only the direction horizontal to the surface of a substrate but also a direction vertical to the same to scan an inspection target pattern, a defect which is present in the pattern of a high aspect ratio can be detected with high sensitivity.

Although the embodiment has been described, the present invention is not restricted thereto, and it can be modified in many ways and applied within its technical scope as a matter of course.

For example, the three pattern images are obtained with respect to each trench pattern in the foregoing embodiment, but a different quantity of pattern images may be obtained and compared with each other as long as the quantity is above one.

Further, although the description has been given as to the example where the pattern image is obtained from the detection signal of the detector 60 and presence/absence of a defect is determined based on the obtained pattern image in the foregoing embodiment, but the presence/absence of a defect can be likewise determined by comparing, e.g., intensity levels of the detection signals without obtaining the pattern image.

In this case, for example, the detection signal from the detector 60 is directly supplied to the defect determination unit 80 without using the signal processing unit 70 in the constituent elements of the pattern inspection apparatus 1 in FIG. 1, and the defect determination unit 80 checks the presence/absence of a defect based on the detection signal.

### (3) Avoidance of Noise Caused by Film Thickness Unevenness of Thin Film

In a pattern inspection in which a pattern of a thin film is an inspection target, interference of light caused due to film thickness unevenness of the thin film results in noise. To avoid such a situation, it is desirable for a light source of the pattern inspection apparatus to have a wavelength width that can cancel the film thickness unevenness. More specifically, a light source having a wavelength width of ±several nm or above is desirable and, for example, a Ti:sapphire triple harmonic femto(10-15)second-order pulse laser having a wavelength of 260 nm±40 nm or below can be used to realize this light source.

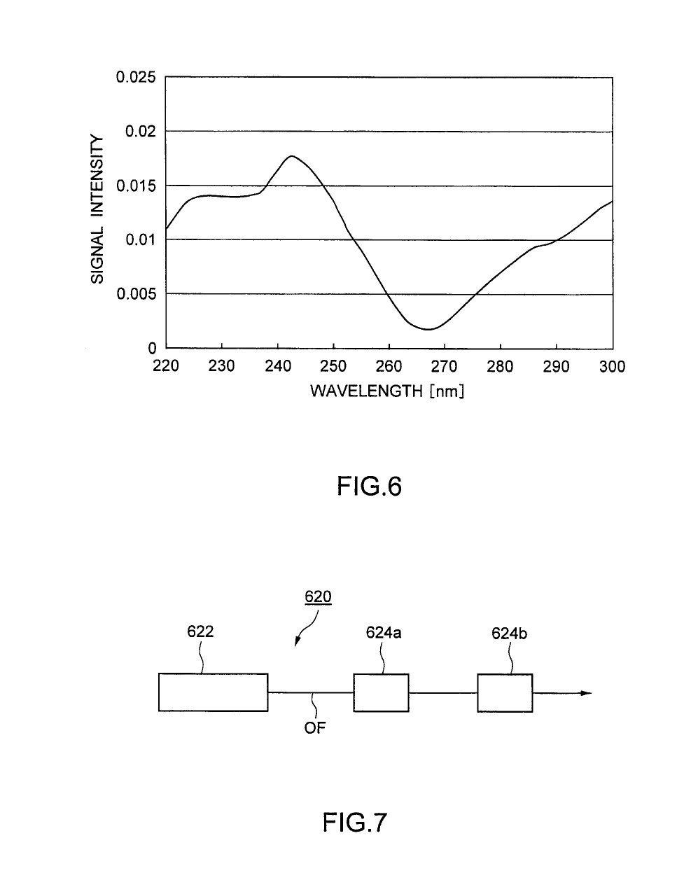

FIG. 6 is a graph chart showing wavelength-dependence of a reflectance from a given defect is obtained by simulation in the pattern inspection apparatus shown in FIG. 1. A reflectance greatly changes in dependence upon a wavelength because of an influence of thin-film interference. Therefore, in the example shown in FIG. 6, the reflectance is reduced in the vicinity of a wavelength of 260 nm. Thus, it can be understood that sufficient sensitivity cannot be obtained by a regular single-wavelength laser. Therefore, for example, in the pattern inspection apparatus depicted in FIG. 1, when a pulse laser light source having a wavelength of 260 nm±several tens of nm is used as the light source 10, an average of integrated intensity of reflectance fluctuation in FIG. 6 serves as signal intensity. As a result, a pattern inspection that is robust to film thickness fluctuation can be conducted.

Moreover, a broadband light source constituted by coupling a plurality of lasers of different wavelengths with each other can be used in place of the pulse laser equipment.

FIG. 7 is a schematic view showing a basic light source unit for generating deep ultraviolet light.

A basic light source unit 620 depicted in FIG. 7 includes an infrared laser diode 622, and SHG (Second Harmonic Generation) elements 624a and 624b which are connected in series. The infrared laser diode 622 and the SHG element 624a are optically connected to each other through an optical fiber OF, and the SHG element 624a and the SHG element 624b are optically connected to each other through the same. The infrared laser diode 622 emits an infrared laser having a wavelength of 1064 nm±0.25 nm. A quadruple harmonic wave is generated from this infrared laser by the two SHG elements 624a and 624b, and deep ultraviolet light is output from the SHG element 624b.

The deep ultraviolet light output from the SHG element 624b has a wavelength width of approximately 266 nm±10 pm since a relationship between the wavelength and the wavelength width is as follows:

Δλ=Δλ266 nm×(λ266 nm×/λ1064 nm)²

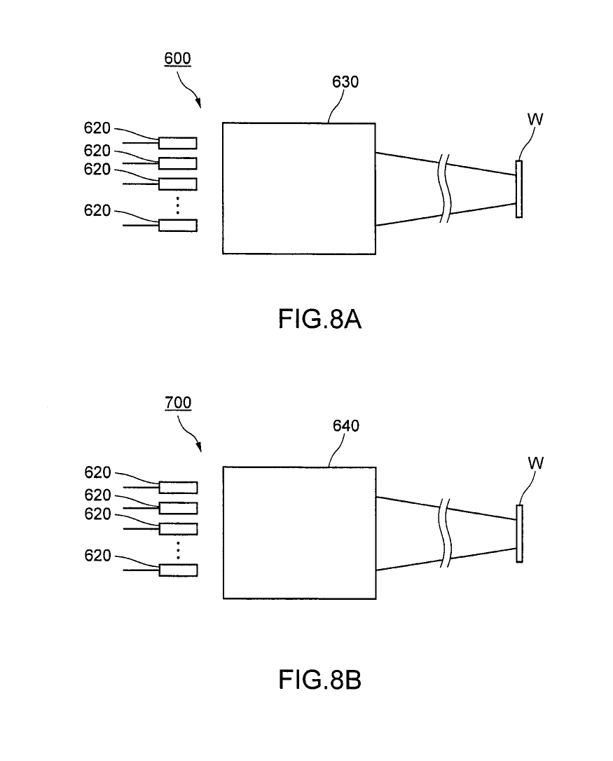

FIGS. 8A and 8B are schematic view showing broadband light sources constituted by using the plurality of basic light source units 620 depicted in FIG. 7.

A broadband light source 600 depicted in FIG. 8A includes 100 basic light source units 620 and a combiner 630. Central wavelengths of the respective basic light source units 620 are different from each other due to temperature control. Additionally, combining deep ultraviolet lights having different central wavelengths by use of the combiner 630 enables obtaining a light source having a desired wavelength width. In accordance with the broadband light source 600 in this example, the light source having a wavelength width ±1.5 nm can be realized. As a matter of course, the light source is not restricted to one having this wavelength width but a light source having a desired wavelength width can be obtained by controlling a central wavelength of outgoing light from the original infrared laser diode 622 and the number of the basic light source units 620.

Furthermore, a broadband light source 700 shown in FIG. 8B includes 100 basic light source units 620 and a homogenizer 640. The homogenizer 640 homogenizes non-uniform light intensity distributions of a plurality of deep ultraviolet lights having different central wavelengths output from the 100 basic light source units 620. As the homogenizer 640, specifically, it is possible to adopt a homogenizer that uses a DOE (Diffractive Optical Element) to control a wave front with diffracted light besides a homogenizer that uses an array lens which bends light by refraction. In this embodiment, the homogenizer 640 corresponds to, e.g., a wavefront homogenization optical system.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern inspection apparatus comprising:
a stage configured to support a substrate with a pattern thereon as an inspection target;
a stage drive unit configured to move the stage in a direction horizontal to the surface of the substrate;
a light source configured to irradiate the substrate with light;
a detection unit configured to detect reflected light from the substrate irradiated with the light and outputs a signal;
an optical system configured to lead the light emitted from the light source to the substrate and to lead the reflected light from the substrate to the detection unit;
a focus position change unit configured to change a focus position of the light to the substrate in a direction vertical to the surface of the substrate;
a control unit configured to associate the movement of the stage with the light irradiation to the pattern and control the stage drive unit and the focus position change unit in a manner that the focus position changes; and
a determination unit configured to determine presence/absence of a defect of the pattern based on the signal from the determination unit.

2. The apparatus of claim 1,
wherein the control unit specifies a position of the pattern from design data of the pattern.

3. The apparatus of claim 1,
wherein the optical system is accommodated in a column, and
the focus position change unit moves the column to change the focus position.

4. The apparatus of claim 3,
wherein the focus position change unit comprises a piezo element configured to move the column.

5. The apparatus of claim 1,
wherein the focus position change unit comprises an element configured to electrically change a refractive index of the light emitted from the light source.

6. The apparatus of claim 1,
wherein the determination unit determines presence/absence of a defect of the pattern from an intensity distribution of the reflected light on a pupil plane.

7. The apparatus of claim 1,
wherein the light source emits a pulse laser having a wavelength width of 40 nm or below.

8. The apparatus of claim 1,
wherein the light source is a broadband light source configured to combine a plurality of lasers having central wavelength widths of ten pm or below and to emit the combined laser, the central wavelengths of the plurality of lasers being different from each other.

9. The apparatus of claim 8,
wherein the light source comprises a wavefront homogenization optical system configured to homogenize light intensity distributions of the plurality of lasers.

10. The apparatus of claim 1,
wherein the pattern as the inspection target comprises first and second patterns formed on different cells or dies in such a manner that they have the same shape and dimension, and
the determination unit determines presence/absence of the defect based on a cell-to-cell comparison or a die-to-die comparison in which a first image obtained by detecting reflected light from the first pattern is compared with a second image obtained by detecting reflected light from the second pattern.

11. The apparatus of claim 10,
wherein each of the first and second images comprises a defocus image.

12. A pattern inspection method comprising:
emitting light from a light source toward a substrate with a pattern thereon as an inspection target;
scanning a surface of the substrate with the emitted light in a direction horizontal to the surface of the substrate while moving a focus position of the light to the substrate in a direction vertical to the surface of the substrate; and
determining presence/absence of a defect of the pattern based on a signal obtained by detecting reflected light from the substrate.

13. The method of claim 12, further comprising:
specifying a position of the pattern from design data of the pattern,
wherein the focus position of the emitted light to the substrate changes depending on the position of the pattern.

14. The method of claim 12,
wherein the focus position of the emitted light to the substrate changes by moving an objective lens or by varying a refractive index of the light emitted from the light source.

15. The method of claim 12,
wherein the presence/absence of the defect of the pattern is determined from an intensity distribution of the reflected light on a pupil plane.

16. The method of claim 12,
wherein the light source emits a pulse laser having a wavelength width of 40 nm or below.

17. The method of claim 12,
wherein the light source is a broadband light source configured to combines a plurality of lasers having central wavelength widths of ten pm or below and to emit the combined laser, the central wavelengths of the plurality of lasers being different from each other.

18. The method of claim 17, further comprising:
homogenizing light intensity distributions of the plurality of lasers.

19. The method of claim 12,
wherein the pattern as the inspection target comprises first and second patterns formed on different cells or dies in such a manner that they have the same shape and dimension, and
the presence/absence of the defect is determined based on cell-to-cell comparison or die-to-die comparison in which a first image obtained by detecting reflected light from the first pattern is compared with a second image obtained by detecting reflected light from the second pattern.

20. The method of claim 19,
wherein each of the first and second images comprises a defocus image.
